(19) United States
(12) Patent Application Publication
(10) Pub. No.: US 2009/0176088 A1
(43) Pub. Date: Jul. 9, 2009

(54) NITRILE GLOVE

(76) Inventor: Kim Meow Lee, Selangor Darul Ehsan (MY)

Correspondence Address: COLLEN IP, THE HOLYOKE MANHATTAN BUILDING, 80 SOUTH HIGHLAND AVENUE, OSSINING, NY, 10562, US

(21) Appl. No.: 12/341,194

(22) Filed: Dec. 22, 2008

(30) Foreign Application Priority Data
Jun. 21, 2006 (MY) PI 20062930

(51) Int. Cl. B32B 25/14

(52) U.S. Cl. 428/337

(57) ABSTRACT

Nitrile rubber compositions and articles of manufacture made therefrom are disclosed. The resulting articles of manufacture, including gloves have ultimate tensile strength and lower modulus which are soft but strong and can be economically manufactured.

### FIELD OF INVENTION

The present invention relates to elastomeric materials, and more particularly relates to flexible nitrile gloves which have good strength and low elastic modulus at a predetermined of thickness.

### BACKGROUND OF THE INVENTION

Nitrile rubber is widely used to make variety of articles of manufacture at a reasonable price. Carboxylated nitrile has high strength and impermeability properties to certain solvents and oils. Compounding and curing the rubber with other components such as processing agents, pH control agents, accelerator agents, curing agents, coagulant, and activators can optimize these properties. Crosslinking also increases the strength and elasticity of the rubber. Carboxylated nitrile latexes can be chemically crosslinked in at least two ways such as the carboxylated acid groups are linked to each other via a reaction with zinc oxide at room temperature which is called ionic crosslinking and unsaturated butadiene blocks are crosslinked via a conventional sulfur/accelerator system at elevated temperatures which is referred as covalent crosslinking.

### SUMMARY OF THE INVENTION

A glove comprising a layer of elastomeric carboxylated nitrile butadiene rubber having a tensile strength of greater than 1450 psi and less than 2600 psi as measured in accordance with ASTM D412 on a sample of the elastomeric material having a thickness from about 3.3 to about 3.85 mils, and zinc oxide in an amount greater than 0.4 parts per hundred and less than 0.9 parts per hundred parts nitrile nitrile butadiene rubber, wherein said glove has a relaxation property greater than 55%.

### DETAILED DESCRIPTION OF THE PREFERRED EMBODIMENTS

The invention provides nitrile rubber compositions useful for manufacturing articles having a good strength and low elastic modulus at a predetermined of thickness than many previously known rubber compositions.

To evaluate the performance of a nitrile glove, relaxation is only one of many physical properties. The higher the relaxation property, the better the glove will fit a hand's shape. Otherwise the glove becomes loose after awhile. But if high relaxation is combined with high modulus, the glove would quickly cause finger fatigue. Tensile strength, modulus, elongation are also very important as required by ASTM. For gloves, the balanced physical properties of high tensile strength and low modulus are preferred product characteristics. The three main components in formulation to affect the desired properties are the crosslinker, primary activator for sulfur vulcanization and the secondary accelerators. Sulfur is used as crosslinker, zinc oxide as the primary activator and zinc dibutyldithiocarbamate as the secondary accelerator. Sulfur content is critical to relaxation.

Nitrile latex can be carboxylated or noncarboxylated but carboxylated nitrile latexes are preferred. Carboxylated nitrile latex suitable for making articles of this invention is commercially available. The metal compounds preferably comprise zinc, magnesium, calcium, cadmium or lead. Their representative compounds are metal oxides, such as magnesium oxide, zinc oxide, calcium oxide, cadmium oxide or lead oxide. Zinc oxide is the preferred metal compound of the present invention. The preferred amount of zinc oxide is from about 0.4 to about 0.9 phr (parts per hundred parts of dry rubber) of nitrile latex rubber. The nitrile mixture can optionally include additives commonly used in making cured latex products, including pigments, platicizers, processing agents, coagulants and the like. A preferred pigment is titanium dioxide, which is useful when a non-transparent article is desired.

The present invention provides a nitrile rubber material which when cured has 500% modulus less than about 350 psi (pounds per square inch). In preferred embodiments, the cured nitrile rubber has a 500% modulus in the range of about 400 to 1450 psi. The nitrile rubber material has a tensile strength greater than 1450 psi but not more than 2600 psi. The cured nitrile rubber material is substantially impermeable to water for example liquid water and water vapor. The gloves produced preferably have a layer of a nitrile rubber having a thickness of between 3.3 to 3.85 mils. Thin gloves provide better feel for the wearer and these gloves are suitable to use as surgical gloves. In the preferred embodiment of the present invention, the nitrile glove has elongation greater than about 700% and preferably greater than about 800%. The tensile strength is the energy required to stretch the sample to the breaking point and the elongation is the percent stretch of the sample at the breaking point.

The elastomeric material of the present invention has elastic properties such than when the elastomeric material is stretched from an initial configuration to fit about an object such as a hand, the elastomeric material conforms to the configuration or the object, initially exerting a predetermined pressure on the object and thereafter relaxing to exert on the object a reduced pressure.

Articles of manufacture can be made from the invention compositions according to methods known in the art. Articles such as gloves and the like are often made by dipping a form into the latex composition, thereby preparing a latex film on the surface of the form. The dwell time of the form in the latex composition can be selected to obtain a film of a desired thickness on the form. The form is preferably dipped in a coagulant solution prior to dipping in the latex composition. Use of a coagulant can result in a cured rubber having increased tensile strength.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1. A glove comprising:
a layer of elastomeric carboxylated nitrile butadiene rubber having a tensile strength of greater than 1450 psi and less than 2600 psi as measured in accordance with ASTM D412 on a sample of the elastomeric material having a thickness from about 3.3 to about 3.85 mils, and zinc oxide in an amount greater than 0.4 parts per hundred and less than 0.9 parts per hundred parts nitrile butadiene rubber, wherein said glove has a relaxation property greater than 55%.
